(19) United States
(12) Patent Application Publication
(10) Pub. No.: US 2021/0315296 A1
(43) Pub. Date: Oct. 14, 2021

(54) Face Masks Provided On A Roll, Methods Of Manufacturing Thereof, And Distribution Assemblies Therefor

(71) Applicants: MARLIN BJERKE, Clear Lake, SD (US); LUKE FAULSTICK, Clear Lake, SD (US)

(72) Inventors: MARLIN BJERKE, Clear Lake, SD (US); LUKE FAULSTICK, Clear Lake, SD (US)

(21) Appl. No.: 17/230,051

(22) Filed: Apr. 14, 2021

Related U.S. Application Data
(60) Provisional application No. 63/009,737, filed on Apr. 14, 2020.

(51) Int. Cl. A41D 13/11; C09J 7/40; B65D 83/08

(52) U.S. Cl. CPC A41D 13/1169; B65D 83/08; C09J 7/40

(57) ABSTRACT

A mask can be positioned on a face of a user to filter respiration of the user. The mask can comprise a filter having a first edge that extends along a first axis and a second edge that is spaced from the first edge along a second axis that is perpendicular to the first axis. First and second material strips having adhesive thereon can be elongated along the first axis. The first and second material strips can overlie the respective first and second edges of the filter so that the first material strip comprises a first portion that overlies the filter and a second portion that extends outwardly from the first portion along the second axis.

### CROSS-REFERENCE TO RELATED APPLICATION

This application claims priority to, and the benefit of the filing date of, U.S. Provisional Patent Application No. 63/009,737, filed Apr. 14, 2020, the entirety of which is hereby incorporated by reference herein.

### FIELD

This application relates to face masks and, in particular aspects, to face masks that are configured to adhere to a face of a user/wearer.

### BACKGROUND

Conventional face masks typically comprise a filter and elastic straps that extend around the ears or head of the user. Such masks can be expensive and uncomfortable. Further, the elastic straps can get in the way of certain activities such as, for example a haircut. Additionally, when distributing such conventional face masks, it is nearly impossible for a single individual to avoid touching multiple masks, thereby potentially contaminating each touched mask.

Accordingly, a more sanitary distribution/dispensation system is desirable.

### SUMMARY

Disclosed herein, in one aspect, is a mask for positioning on a face of a user to filter respiration of the user. The mask can comprise a filter having a first edge that extends along a first axis and a second edge that is spaced from the first edge along a second axis that is perpendicular to the first axis. A first material strip can have adhesive thereon. The first material strip can be elongated along the first axis. The first material strip can overlie the first edge of the filter so that the first material strip comprises a first portion that overlies the filter and a second portion that extends outwardly from the first portion along the second axis. A second material strip can have adhesive thereon. The second material strip can be elongated along the first axis. The second material strip can overlie the second edge of the filter so that the second material strip comprises a first portion that overlies the filter and a second portion that extends outwardly from the first portion along the second axis.

A mask dispensing system can comprise a container having a first end and a second end that is spaced from the first end along a stacking axis. The container can define an interior between the first end and the second end. The first end of container can define an opening at the first end. A plurality of masks can be positioned within the interior of the container in a stacked arrangement along the stacking axis.

An article can comprise plurality of masks, wherein each mask of the plurality of masks is coupled to at least one adjacent mask of the plurality of masks.

Additional advantages of the disclosed system and method will be set forth in part in the description which follows, and in part will be understood from the description, or may be learned by practice of the disclosed system and method. The advantages of the disclosed system and method will be realized and attained by means of the elements and combinations particularly pointed out in the appended claims. It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the disclosed apparatus, system, and method and together with the description, serve to explain the principles of the disclosed apparatus, system, and method.

FIG. 1A is a top view of a mask in accordance with embodiments disclosed herein.

FIG. 1B is an exploded side view of the mask as in FIG. 1A.

FIG. 2 illustrates a schematic of a system for manufacturing a product roll comprising a plurality of masks as in FIG. 1A.

FIG. 3 illustrates a schematic of a dispenser for dispensing masks from the product roll of FIG. 2.

FIG. 4A is a top view of an exemplary mask in accordance with embodiments disclosed herein. FIG. 4B is an exploded view of the mask of FIG. 4A.

FIG. 5 is a top view of a mask in accordance with embodiments disclosed here.

FIG. 6 is an exploded side view of a mask in accordance with embodiments disclosed herein.

FIG. 7 is a side view of an assembly comprising a mask and a release liner as disclosed herein.

FIG. 8 is a side view of an assembly comprising a mask and a release liner as disclosed herein.

FIG. 9 is a schematic diagram of a system for manufacturing a product roll comprising a plurality of masks as disclosed herein.

FIG. 10 is a schematic diagram of a mask dispensing system in accordance with embodiments disclosed herein.

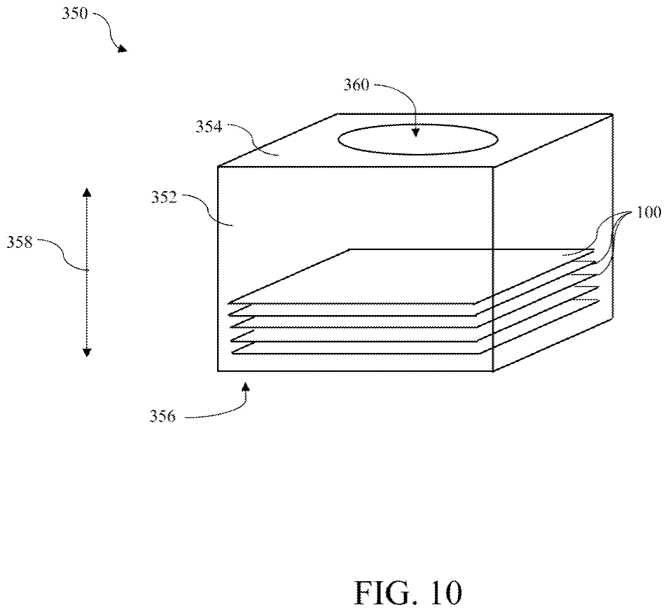

### DETAILED DESCRIPTION

The disclosed system and method may be understood more readily by reference to the following detailed description of particular embodiments and the examples included therein and to the Figures and their previous and following description.

It is to be understood that the terminology used herein is for the purpose of describing particular embodiments only and is not intended to limit the scope of the present invention which will be limited only by the appended claims.

It must be noted that as used herein and in the appended claims, the singular forms “a,” “an,” and “the” include plural references unless the context clearly dictates otherwise. Thus, for example, reference to “a layer” includes one or more of such layers, and so forth.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Optionally, in some aspects, when values or characteristics are approximated by use of the antecedents “about,” “substantially,” or “generally,” it is contemplated that values within up to 15%, up to 10%, up to 5%, or up to 1% (above or below) of the particularly stated value or characteristic can be included within the scope of those aspects. Similarly, in some aspects, “generally parallel” can refer to orientations within 15 degrees, within 10 degrees, within 5 degrees, or within 1 degree of parallel.

Unless defined otherwise, all technical and scientific terms used herein have the same meanings as commonly understood by one of skill in the art to which the disclosed apparatus, system, and method belong. Although any apparatus, systems, and methods and materials similar or equivalent to those described herein can be used in the practice or testing of the present apparatus, system, and method, the particularly useful methods, devices, systems, and materials are as described.

Throughout the description and claims of this specification, the word “comprise” and variations of the word, such as “comprising” and “comprises.” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

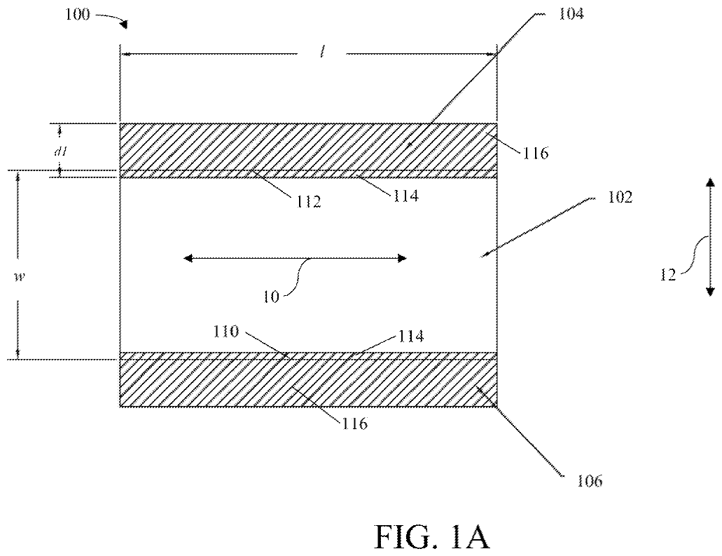

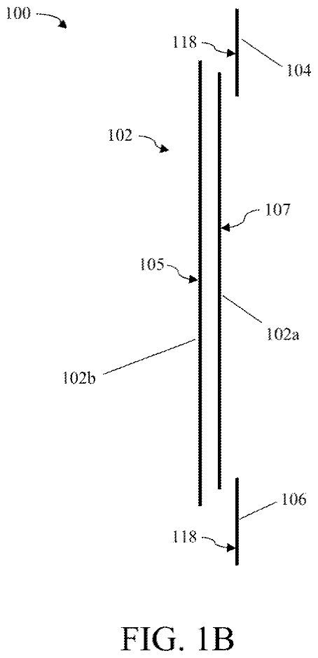

Disclosed herein, in various aspects and with reference to FIG. 1A is a mask 100. The mask 100 can be configured to at least partially filter air passing therethrough to remove viruses, bacteria, and dust. In some optional aspects, the mask can comprise at least one layer that acts as a filter 102. In some aspects, the filter 102 can be a single layer (e.g., single-ply) filter. In further aspects, the mask 100 can comprise two, three, or more layers that are bonded together to form a multi-layer filter (e.g., a two-ply or three-ply filter), thereby increasing the level of filtration provided by the filter. For example, in some aspects, the filter 102 can comprise an outer layer 102a and an inner layer 102b. Optionally, the layers can be bonded together via an adhesive. Each of the layers can comprise woven or nonwoven (e.g., meltblown or spunbond) material, or any suitable material. For example, in some optional aspects, one or more of the layers can comprise paper, cloth (e.g., cotton or a synthetic material), polymer (e.g., polypropylene, rayon, polyester or a combination thereof), or carbon fiber. The two or more layers can be the same or different materials. The filter 102 can define an inner surface 105 and an opposed outer surface 107. The inner surface 105 can face (optionally, be positioned against) the face of the wearer.

The filter 102 of the mask 100 can have a length, l, and a width, w. Optionally, the mask can be arranged to extend lengthwise across the face of the wearer with the width extending vertically along the face of the wearer. In some optional aspects, the filter 102 can have a width of 3.5 inches and a length of 7 inches. In further optional aspects, the filter 102 can have a length of 8.5 inches and a width of 8.18 inches. In still further aspects, any suitable dimensions can be selected based on the user preferences, the application, regulatory requirements, etc. For example, in various aspects, the filter 102 can have a length from about 5 inches to about 10 inches (e.g., from about 6 inches to about 9 inches, from about 7 inches to about 8 inches, or from about 8 inches to about 9 inches). In various aspects, the filter 102 can have a width from about 3 inches to about 9 inches (e.g., from about 3.5 inches to about 7 inches, from about 3.5 inches to about 4.5 inches, or from about 4 inches to about 5 inches).

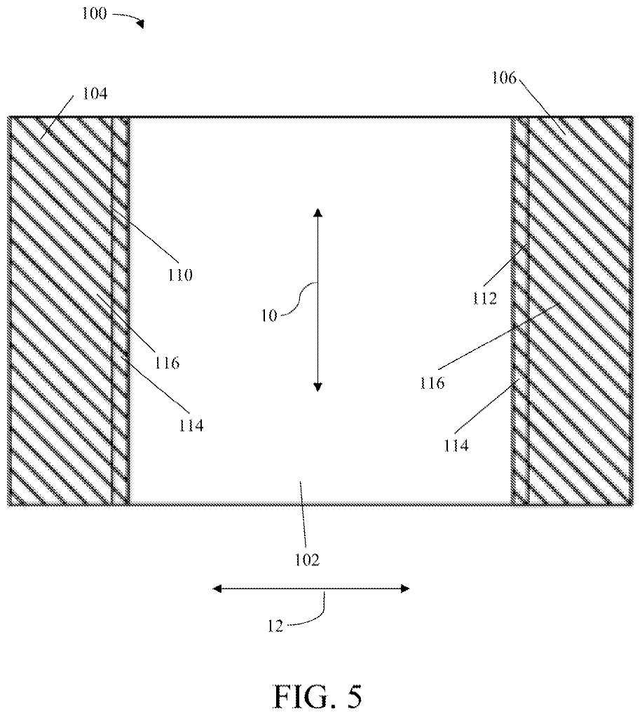

In some optional aspects, the mask 100 can be configured to attach to the face of the user via adhesive. In these aspects, it is contemplated that the mask 100 can comprise at least one adhesive region associated with the interior of the mask and configured to face the face of the user. For example, the mask 100 can comprise a first adhesive strip 104 that extends along the first edge of the mask and a second adhesive strip 106 that extends along a second edge of the mask. Optionally, as illustrated in FIG. 1A, the first and second adhesive strips 104, 106 can extend along longitudinally extending edges of the mask. Thus, in some aspects, the first and second adhesive strips 104, 106 can extend along upper and lower edges so that the adhesive strips can extend laterally across the face of the wearer. In further optional aspects, as illustrated in FIG. 5, the first and second adhesive strips can extend along transversely extending edges of the mask. Thus, in some aspects, the first and second adhesive strips 104, 106 can extend vertically along the face of the wearer (e.g., along the cheeks of the wearer). Optionally, in these aspects, the mask can have a length in the vertical dimension (along the first axis 10) and a width (along the second axis 12) that is shorter than the length. The first and second adhesive strips 104, 106 can have an adhesive on a first side 118 of the respective adhesive strips that is configured to engage the face of the wearer. Optionally, each of the first and second strips can have a width, d1, of less than 2 inches, less than 1.5 inches, or about 1 inch. In some optional aspects, the first and second strips can have a length that is equal to the dimension of the filter along the first axis.

Optionally, it is contemplated that the mask 100 can have no adhesive between the first and second adhesive strips 104. Thus, the mask 100 can be unattached from the face of the wearer/user between the first and second adhesive strips 104.

Referring to FIGS. 1A-1B, in some aspects, the filter 102 can have a first edge 110 extending along a first axis 10 and an opposed second edge 112 that is spaced from the first edge 110 along a second axis 12 that is perpendicular to the first axis 10. Optionally, the second edge 112 can extend parallel to, or generally parallel to the first edge 110. Accordingly, in some optional aspects, the filter 102 can be rectangular. The first and second adhesive strips 104, 106 can be positioned against the outer side 107 of the filter 102. The first and second adhesive strips 104, 106 can extend across (e.g., inwardly and outwardly of) the respective first and second transverse sides 110, 112 so that a portion 114 of the respective strip overlies and adheres to the filter 102 and a portion 116 of the first and second adhesive strips extend beyond (e.g., outwardly of) the filter in order to adhere to the face of the user. In some optional aspects, the first and second adhesive strips 104, 106 can be bonded to the filter 102 using conventional bonding means used in forming laminar assemblies. In some optional aspects, the filter layers can be staggered so that the outer-most layer has a smaller dimension along the second axis 12 than the inner-most layer. In this way, the adhesive on both of the adhesive strips 104, 106 can engage each of the layers (edges of both the outer-most layer and the inner-most layer), thereby coupling the layers together. In further aspects of embodiments having multiple filter layers, the filter layers can be coupled together via conventional lamination means.

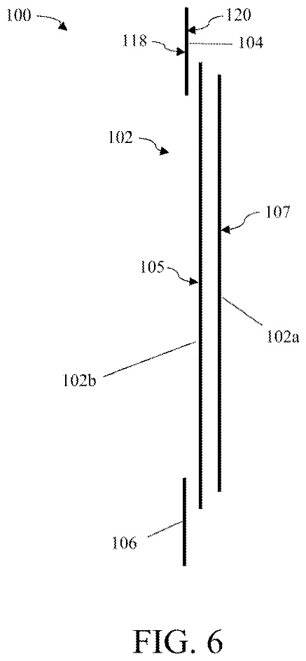

In further optional aspects, as shown in FIG. 6, a second (outer) side 120 of the adhesive strips 104, 106 can be positioned against, and coupled to, the inner surface 105 of the filter 102, and the adhesive for engagement with the face of the user can be disposed on the first side 118 of the adhesive strips 104, 106.

In some optional aspects, the first and second adhesive strips 104, 106 can be foam strips. In further aspects, the adhesive can be provided on a non-foam polymer or paper material or deposited directly onto the filter 102. The adhesive can be a medical-grade adhesive or any other adhesive that is suitable for skin contact.

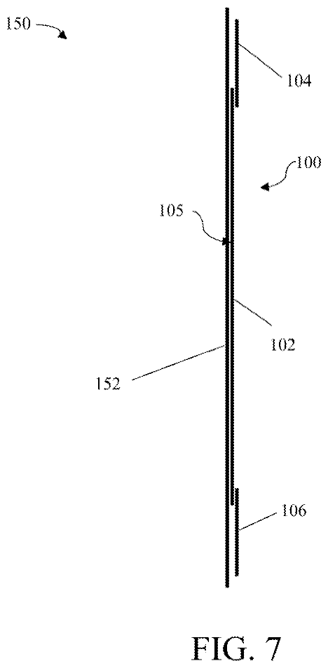

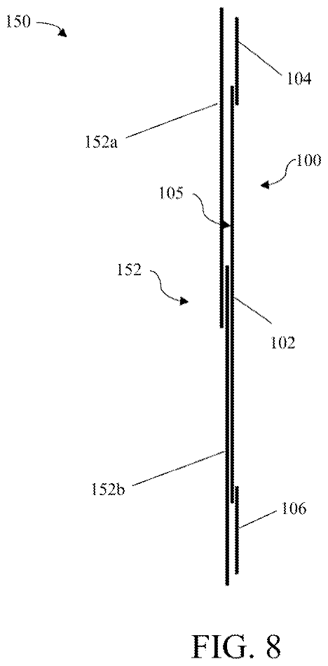

Referring to FIG. 7, in some aspects, an assembly 150 can comprise a mask 100 and a release liner 152. The release liner 152 can extend across the adhesive of the adhesive strips 104, 106. In some aspects, the release liner 152 can comprise a single, continuous sheet that extends across the adhesive strips 104, 106 and the inner surface 105 of the filter 102. In this way, the release liner can both protect the adhesive of the mask as well as protect the filter to keep the inner surface of the filter sanitary. In further optional aspects, referring to FIG. 8, the release liner 152 can comprise separate elements (e.g., first and second release strips 152a, 152b) that cover each adhesive strip 104, 106. The first and second separate strips 152a, 152b can optionally overlap so that a portion of the first strip 152a overlies at least a portion of the second strip 152b. In this way, the release liner can both protect the adhesive of the mask as well as protect the filter to keep the inner surface of the filter sanitary.

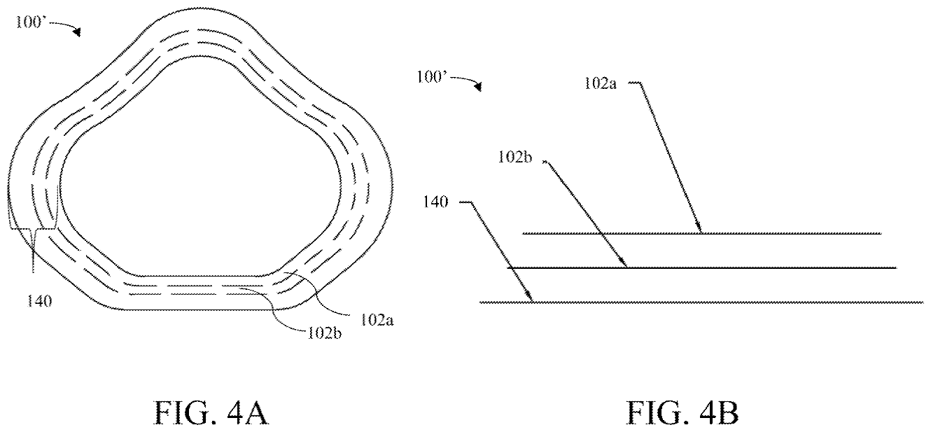

In further optional aspects, with reference to FIGS. 4A and 4B, a mask 100′ can comprise an adhesive 140 that defines a complete perimeter to seal around the face of the user so that all or substantially all of the air to and from the user passes through the filter.

Optionally, in exemplary aspects, when the mask comprises an adhesive that engages the face of the user, the mask does not comprise straps that are configured to extend around the head of the user or over the ears of the user.

In still further optional aspects, the masks can comprise one or more straps that are configured to extend around the head of the user or over the ears of the user. Optionally, in these aspects, the adhesive strips can be excluded.

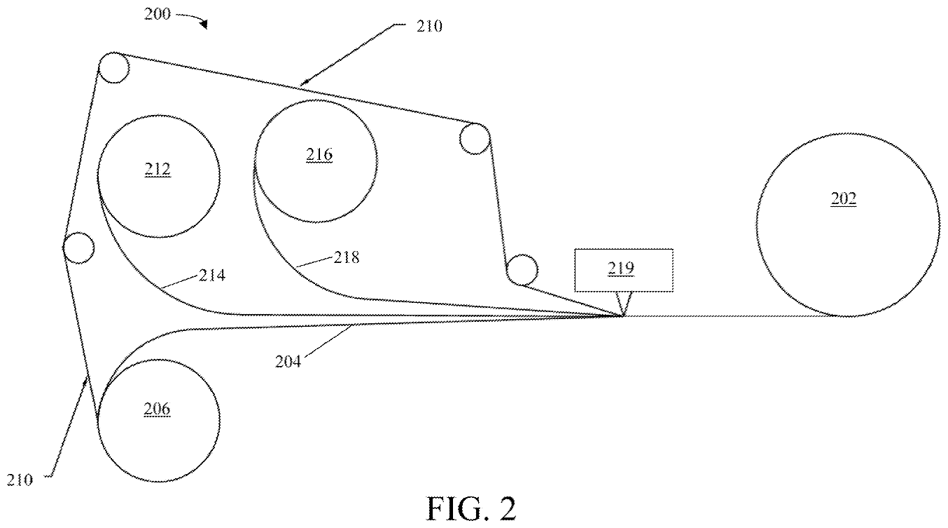

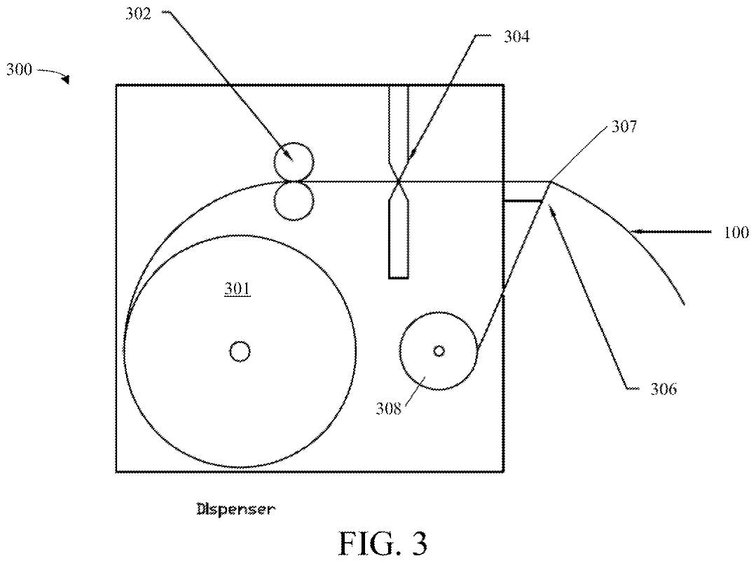

In some aspects, the masks 100 can be provided on a product roll 202 (FIG. 2). For example, the masks 100 can be integrally formed with each other (optionally, with perforations therebetween) so that single masks can be separated (e.g., cut or torn) from the product roll 202 for use. That is, each mask can be coupled to at least one adjacent additional mask on the roll. In further optional aspects, the masks can be provided on a substrate (e.g., the release liner 210, as shown in FIGS. 2 and 3) that is provided on a roll. Portions of the substrate, with respective masks attached thereto, can be removed from the roll (e.g., the substrate can be torn at a perforation or cut via a dispenser blade). Thus, as further disclosed herein, individual masks can be distributed to multiple users without any one user touching multiple masks.

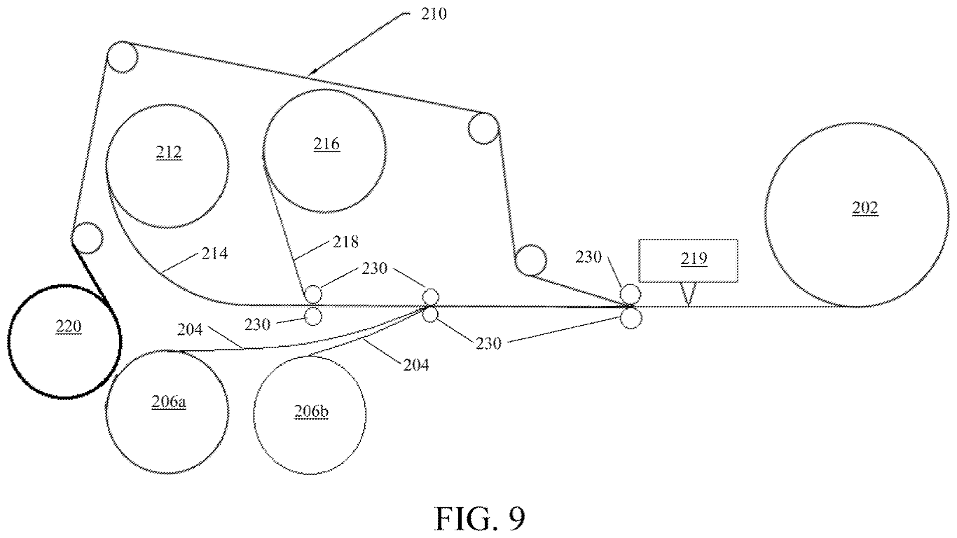

Referring to FIGS. 2 and 9, the masks 100 can be formed on the product roll 202 via a conversion system 200. For example, an adhesive strip material 204 (e.g., tape) can be provided on a first raw material roll 206. In some optional aspects, the first raw material roll 206 can comprise the adhesive strip material 204 and a separable (release) liner 210. The adhesive strip material 204 can comprise, for example, the foam strip(s) with adhesive deposited thereon for forming the first and second adhesive strips 104, 106, as disclosed herein. In alternative optional aspects, as shown in FIG. 9, a separate roll (or rolls) 220 can provide the liner 210, and the adhesive strip material 204 can be provided on different raw material roll (or different rolls). Although shown as a single roll 206 in FIG. 2, it is contemplated that each of the first and second adhesive strips 104, 106 can be provided on separate raw material rolls 206a and 206b (FIG. 9).

A second raw material roll 212 can provide a first material 214 for providing a first layer of the filter 102, and a third raw material roll 216 can provide a second material 218 for providing a second layer of the filter 102. In further aspects, it is contemplated that any selected number of raw material rolls can be used to apply respective layers (plies) of the filter 102, thereby permitting modification of the level of filtration provided by the filter. For example, in some aspects, a second raw material roll 212 can provide a first material, which can optionally form a single layer (e.g., single-ply) filter. In further aspects, a third material roll 216 can provide a second material, which can form a second layer of the filter. Similarly, it is contemplated that additional material rolls (e.g., a fourth material roll) can form additional layers of the filter (e.g., a third layer).

The adhesive strip material 204 can be separated from the liner 210. In order from a first side to a second side (e.g., bottom to top) of the mask, the adhesive strip material 204, the first material 214, the second material 218, and the liner 210, can be pressed together (e.g., between rollers 230 (FIG. 9)). An adhesive, which can optionally be the adhesive on the adhesive strip material, can bind all of the layers together. In further optional aspects, it is contemplated that an adhesive can be deposited onto at least one of the materials before or after the materials are coupled together. In still further aspects, at least two materials can be heat-bonded together (e.g., using conventional means). Optionally, a perforation cutter 219 can intermittently form perforations in the coupled material to provide segments that can be separated from each other to form individual masks. In further aspects, as described herein, a dispenser can perforate or cut portions of the coupled materials. Thus, the coupled materials (optionally, with perforations therein) can form a product. The product can then be wound around the product roll 202. The conversion system 200 can optionally use conventional conversion/lamination equipment as is well-known in the art.

Although described herein as product sheets, it should be understood that the product can be provided in sheets, similar to label sheets, as known in the art. Thus, in some aspects, the sheets can be formed into stacks. In some aspects, the sheets can be coupled to each other at perforated edges, and the sheets can be stacked in an accordion fold manner so that the masks are stacked in an alternating order (e.g., the outer surfaces of the filters of the masks alternatingly facing upwardly and downwardly). In further aspects, the sheets can be entirely separated, and the sheets can be stacked in a common, non-alternating arrangement (e.g., an outer surface of the filter of a first mask biasing against a release liner of an adjacent mask).

Referring to FIG. 9, in some aspects, a dispensing system 350 can comprise a plurality of masks 100 provided in a container 352. In some aspects, the container 352 can be a box (optionally, a rectangular prism), such as, for example, a cardboard box. The container 352 can have a first end 354 (e.g., a top) and a second end 356 (e.g., a bottom) that is spaced from the first end along an axis 358. The plurality of masks 100 can be received within the box in a stacked arrangement, stacked along the axis 358. The first end 354 can define an opening 360. In this way, a user reaching through the opening 360 to pull a mask therefrom can only touch a single mask at a time, inhibiting the user from touching the other masks within the container 352. Optionally, the plurality of masks 100 can be received within the box so that all of the release liners 152 face the opening 360. Thus, a user reaching through the opening will contact the release liner, thereby inhibiting touching of the filter of the mask. In further optional aspects, the plurality of masks 100 can be received within the box so that the outer surfaces 107 of the filters 102 of each mask face the opening 360.

Referring to FIG. 3, in exemplary aspects, the product roll can be provided on a dispenser 300 to dispense individual masks. In some optional aspects, the dispenser 300 can optionally be like or identical to label dispensers, such as those provided by ULINE. A product roll that can be separated into a plurality of dispensed masks can be positioned within, or in engagement with, the dispenser. The dispenser can comprise rollers 302 for moving (e.g., via motor powered roller rotation) or directing movement (e.g., via idler rollers) of the product. The product (e.g., uncut or perforated masks) can optionally pass through a cutter 304 that can select dimension of the dispensed mask (e.g., the length or the width, defined between cuts). Thus, in some optional aspects, the select dimension (e.g., the length or the width) of the mask 100 can be adjustable based on the cutter settings. The cutter 304 can be configured to slice entirely through, partially through, or provide a perforated cut through the product. The dispenser can define an outlet 306 from which a dispensed mask can extend. Optionally, the dispenser can comprise a liner takeup roll 308. The dispensed mask can extend outwardly from the dispenser, and the takeup roll can pull the liner back at a sharp angle from a lip 307 to separate the mask from the liner. For embodiments in which the product is perforated, the user can tear the mask at the perforation. Optionally, the user pulling on the mask can dispense a subsequent mask. In further aspects, the dispenser can comprise a motor or other actuator that dispenses a single mask upon a condition (e.g., a previous mask being removed, or a user waving a hand in front of an optical sensor). Optionally, in these aspects, it is contemplated that the motor or actuator can automatically apply a pulling force to separate an individual mask from the remainder of the roll. Optionally, the motor or actuator can cooperate with a cutting element to separate the individual mask from the roll. When the dispenser provides masks in an automated fashion based on sensing a condition, it is contemplated that the dispenser can comprise a computing device (e.g., a microcontroller) that is communicatively coupled to one or more sensors that are configured to provide an indication of one or more parameters that can be processed by the computing device to determine if the condition is met (e.g., if a motion sensor is sensing motion or if an optical sensor senses an absence of a mask due to one being removed). Optionally, the computing device can comprise a processor and a memory storing instructions that can be executed by the computing device to determine whether a condition is met and to control automated dispensing of masks as further disclosed herein. Although some embodiments for dispensers are described, it should be understood that the dispenser can employ various aspects known and used in the art, such as, for example, aspects of label dispensers and paper towel dispensers.

The dispenser can be provided at, for example, a store, hospital, sporting event, or large gathering of individuals. The masks can be dispensed without any single individual touching multiple masks. The individual (user) can apply the mask directly to her face and cover the mouth and nose with the adhesive strips adhering to the skin. Optionally, the mask can be removed and reattached one or more times for realignment or for multiple use. In further aspects, the mask can be discarded after a single use. For example, it is contemplated that a building or enclosed space can have a dispenser positioned by each entrance to the building and receptacles near the building exits for collecting used masks.

As described herein, a mask that can filter airborne particulates can be manufactured and provided to users at a cheap cost. Optionally, the masks can be formed using conventional laminating/converting equipment. The masks can be provided in sheets or rolls that can be placed in an automatic dispensing machine (e.g., a labeler), automatic paper towel dispenser, or other dispenser for safe, germ-free dispensing. In some aspects, the mask can adhere to the face of the user using medical grade adhesive tape/foam/etc., which can, in some circumstances, be preferable over elastic bands or strips (and, optionally, avoid the need for using such elastic bands or strips).

Those skilled in the art will recognize, or be able to ascertain using no more than routine experimentation, many equivalents to the specific embodiments of the method and compositions described herein. Such equivalents are intended to be encompassed by the following claims.

What is claimed is:

1. A mask for positioning on a face of a user to filter respiration of the user, the mask comprising:
a filter having a first edge that extends along a first axis and a second edge that is spaced from the first edge along a second axis that is perpendicular to the first axis;
a first material strip having adhesive thereon, wherein the first material strip is elongated along the first axis, wherein the first material strip overlies the first edge of the filter so that the first material strip comprises a first portion that overlies the filter and a second portion that extends outwardly from the first portion along the second axis; and
a second material strip having adhesive thereon, wherein the second material strip is elongated along the first axis, wherein the second material strip overlies the second edge of the filter so that the second material strip comprises a first portion that overlies the filter and a second portion that extends outwardly from the first portion along the second axis.

2. The mask of claim 1, wherein the filter has an inner surface and an outer surface, wherein each of the first and second strips has an adhesive on a first side, wherein the first side of each of the first and second strips opposes the outer surface of the filter.

3. The mask of claim 1, wherein the second edge is parallel to the first edge, and wherein the filter is rectangular.

4. The mask of claim 1, wherein the filter has a length along the first axis, wherein the first and second adhesive strips each have a respective length along the first axis, wherein the length of the filter is equal to the length of the first adhesive strip and the length of the second adhesive strip.

5. The mask of claim 1, wherein the first and second material strips each comprise foam.

6. The mask of claim 1, wherein the adhesive is a medical grade adhesive.

7. The mask of claim 1, further comprising a release liner positioned across the first material strip and the second material strip.

8. The mask of claim 7, wherein the release liner comprises:
a first element that extends across the first material strip; and
a second element that extends across the second material strip,
wherein at least a portion of the first element overlies at least a portion of the second element.

9. The mask of claim 1, wherein the mask does not comprise adhesive between the first material strip and the second material strip.

10. The mask of claim 1, wherein the filter has a length along the first axis and a width along the second axis, wherein the length is greater than the width.

11. A mask dispensing system comprising:
a container having a first end and a second end that is spaced from the first end along a stacking axis, wherein the container defines an interior between the first end and the second end, wherein the first end of the container defines an opening at the first end;
a plurality of masks positioned within the interior of the container in a stacked arrangement along the stacking axis, wherein each mask of the plurality of masks comprises:
a filter having a first edge that extends along a first axis and a second edge that is spaced from the first edge along a second axis that is perpendicular to the first axis, wherein each of the first axis and the second axis is perpendicular to the stacking axis;
a first material strip having adhesive thereon, wherein the first material strip is elongated along the first axis, wherein the first material strip overlies the first edge of the filter so that the first material strip comprises a first portion that overlies the filter and a second portion that extends outwardly from the first portion along the second axis; and
a second material strip having adhesive thereon, wherein the second material strip is elongated along the first axis, wherein the second material strip overlies the second edge of the filter so that the second material strip comprises a first portion that overlies the filter and a second portion that extends outwardly from the first portion along the second axis.

12. The mask dispensing system of claim 10, wherein the filter of each mask of the plurality of masks has an inner surface and an outer surface, wherein each of the first and second strips of each mask of the plurality of masks has an adhesive on a first side, wherein the first side of each of the first and second strips opposes the outer surface of the respective filter.

13. The mask dispensing system of claim 10, wherein each mask of the plurality of masks further comprises a release liner positioned across the first material strip and the second material strip.

14. The mask dispensing system of claim 13, wherein each mask of the plurality of masks is disposed within the container with the release liner facing the opening of the container.

15. The mask dispensing system of claim 10, wherein the container is a cardboard box.

16. The mask dispensing system of claim 10, wherein the filter of each mask of the plurality of masks has a length along the first axis and a width along the second axis, wherein the length is greater than the width.

17. An article comprising:
a plurality of masks, each mask comprising:
a filter having a first edge that extends along a first axis and a second edge that is spaced from the first edge along a second axis that is perpendicular to the first axis;
a first material strip having adhesive thereon, wherein the first material strip is elongated along the first axis, wherein the first material strip overlies the first edge of the filter so that the first material strip comprises a first portion that overlies the filter and a second portion that extends outwardly from the first portion along the second axis; and
a second material strip having adhesive thereon, wherein the second material strip is elongated along the first axis, wherein the second material strip overlies the second edge of the filter so that the second material strip comprises a first portion that overlies the filter and a second portion that extends outwardly from the first portion along the second axis,
wherein each mask of the plurality of masks is coupled to at least one adjacent mask of the plurality of masks.

18. The article of claim 17, wherein the article defines a perforation between each mask of the plurality of masks.

19. The article of claim 17, wherein each mask of the plurality of masks is integrally formed with each other mask of the plurality of masks.

20. The article of claim 17, wherein the plurality of masks are provided on a roll.
